(19) United States
(12) Patent Application Publication
(10) Pub. No.: US 2005/0144097 A1
(43) Pub. Date: Jun. 30, 2005

(54) Method and apparatus for accelerated payment of client costs

(76) Inventor: Steven W. Lundberg, Edina, MN (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 11/026,428

(22) Filed: Dec. 30, 2004

Related U.S. Application Data
(60) Provisional application No. 60/533,304, filed on Dec. 30, 2003.

(51) Int. Cl. G06F 17/60

(52) U.S. Cl. 705/30

(57) ABSTRACT

According to one example embodiment, the daily (business days for accelerated) operation of a collection server provides for nightly downloads of out-of-pocket cost file from accounting system, wherein this file shows all out-of-pocket costs entered into the accounting system in the prior period (e.g. day) that are going to be billed to client, typically at the end of the month, and for each cost, a client #, file #, cost, description. In addition, the server searches the list for files for clients selected for “accelerated pay” and, optionally, aggregate costs for each client (if there are muliple costs entered, ask for one payment for all costs added together), and for selected clients, auto debit or send request for approval of funds (per setting). If the client is set up for auto debit, the system automatically takes funds from credit card or bank account (e.g. using ACH) and notice is sent if desired. Otherwise, request to approve fund transfer is sent by e-mail, and client logs onto web page directed from link in e-mail and approves or declines payment. Also, the server checks for successful payments of fees using a batch upload file from a bank (ACH) or credit card processing service and provides a periodic download of auditing file from accounting system.

This application claims benefit under 35 U.S.C. § 119(e) to Application No. 60/533,304 filed Dec. 30, 2003 which is incorporated herein by reference.

### TECHNICAL FIELD OF THE INVENTION

The inventive subject matter pertains to the field of accounting systems, and more particularly to electronic payment systems.

### BACKGROUND

A problem faced by many attorneys, and patent attorneys in particular, is financing out-of-pocket client costs. The logistics of collecting these as retainers prior to expending them is time consuming, particularly due to procedures required for the safe and ethical handling of client retainers. On the other hand, billing these costs along with professional service fees means that the average time to collection of such costs is 30-90 days after they costs are expended.

### IN THE DRAWINGS

FIG. 1 is a simplified block diagram of one embodiment of the system of the invention subject matter.

FIG. 2 is a simplified block diagram of a method according to one example embodiment.

### DETAILED DESCRIPTION

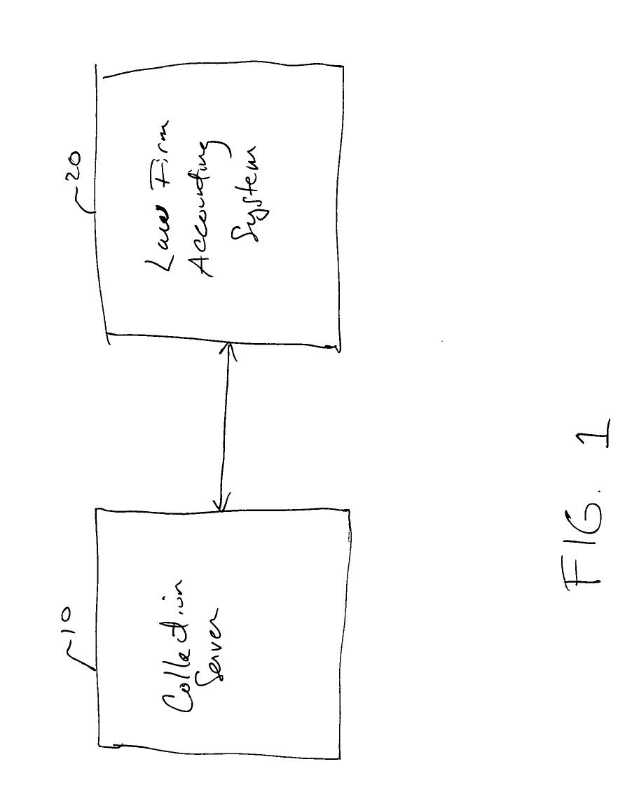

According to a first embodiment of the inventive subject matter herein, a collection server 10 is provided as illustrated in FIG. 1. Server 10 is interfaced with a law firm accounting system 20, or other sources of data useful to accomplish its purpose. The server 10 is set up as follows:
upload law firm client list to load Client List (initial upload with updates preferably automatically pulled from law firm accounting system file but otherwise entered manually)
pick/select clients to do “accelerated collection” for
set parameters per selected client
   accumulate costs for number of days prior to billing: 0-30 days for example
   auto debit (with e-mail notice) or send request for payment each time
   override default service fee with customized service fee
   override default e-mail message with custom client message
   allow law firm to set up credit card or account # for client, or send message to client to get them to provide data by self service

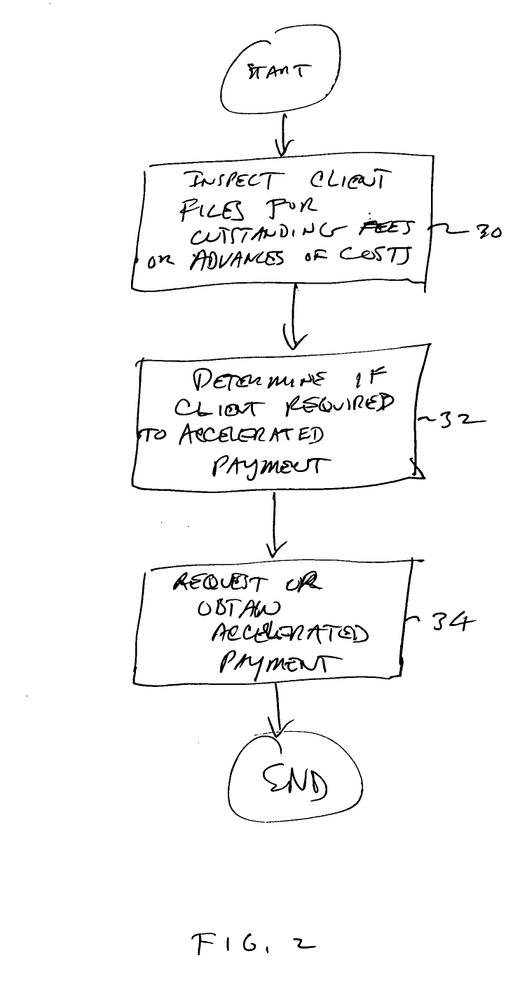

According to one example embodiment shown in FIG. 2, accounting records are inspected 30 to determine if there are recent advances or legal fees. If there are, it is determined 32 if the client for which such costs or fees exist is subject to accelerated payment. If so, an electronic request or debit 34 is made to obtain payment.

According to one example embodiment, the daily (business days for accelerated) operation of the server is as follows:
first, nightly download of out-of-pocket cost file from accounting system:
   this file shows all out-of-pocket costs entered into the accounting system in the prior period (e.g. day) that are going to be billed to client, typically at the end of the month
   for each cost, there is client #, file #, cost, description
next, search list for files for clients selected for “accelerated pay”
   aggregate costs for each client (if there are muliple costs entered, ask for one payment for all costs added together)
   for selected clients, auto debit or send request for approval of funds (per setting)
   if client set up for auto debit, system automatically takes funds from credit card or bank account (e.g. using ACH) and notice is sent if desired. Otherwise, request to approve fund transfer is sent by e-mail, and client logs onto web page directed from link in e-mail and approves or declines payment
also, server checks for successful payments of fees
   batch upload file from bank (ACH) or credit card processing service
      check off payments received
   create payment received file
      client #, file #, credit amount, description
   create “credit” file of payments received and output file to accounting system
nightly download of auditing file from accounting system
   client #, file#, cost credited from PTFM, description
   compare against previous nights uploaded file
   note any discrepancies

In addition, according to this example embodiment, the law firm accounting system uploads the credit file each evening (or other convenient time) and posts a credit against the corresponding file. The originally posted out-of-pocket expense is then offset with a credit once the expense is collected by accelerated pay.

According to yet another example embodiment, the law firm accounting system provides that a client account may be marked for “accelerated payment” of client out-of-pocket expenses. The accounting system can, accordingly, in this embodiment, perform the debit of a client credit card or bank account, and upon successful completion of the debit, post a credit or other type of payment to offset the originally entered client cost.

In either embodiment, professional services for corresponding files or matters may be billed in the normal payment manner, typically once per month.

According to the inventive subject matter herein, “accelerated payment” means requesting payment of an out-of-pocket cost or fee, such as a payment to a patent or trademark office for fees, or a payment for foreign associate services on a patent or trademark matter, on a time schedule that is faster than that normally used for billing of professional service fees for the client in question. In one example embodiment, this request for payment occurs within a day of the posting of the out-of-pocket cost to the accounting system, or within a week of the posting of such an out-of-pocket cost. Or, such payment is requested once per month at the end of a monthly billing cycle, but payment is requested immediately as opposed to allowing the client a customarily longer period to review and approve payment of professional service fees.

Thus, according to the inventive subject matter disclosed herein, client costs may be billed immediately after they are incurred by electronic means, while professional service fees may be billed, for example, on a monthly or other billing cycle that is not immediately after the cost is incurred.

1. A method comprising:
specifying a client in a law firm accounting system for accelerated payment of client costs;
following entry of a client cost in the accounting system, automatically electronically requesting the client to make an electronic payment for the client costs;
otherwise billing professional service fees for the client on a different basis; and
electronically collecting the client cost and entering a credit for payment of the cost in the law firm accounting system.

2. A method comprising:
specifying a client in a law firm accounting system for accelerated payment of client costs;
following entry of a client cost in the accounting system, automatically electronically debiting the clients funds for payment of the client costs;
otherwise billing professional service fees for the client on a different basis; and
electronically collecting the client cost and entering a credit for payment of the cost in the law firm accounting system.

3. A method comprising:
specifying a client for accelerated payment of client costs;
following entry of a client cost in the accounting system, automatically electronically requesting the client to make an electronic payment for the client costs;
otherwise billing professional service fees for the client on a different basis; and
electronically collecting the client cost and entering a credit for payment of the cost in the law firm accounting system.

4. A method comprising:
specifying a client for accelerated payment of client costs;
following entry of a client cost in the accounting system, automatically electronically debiting the clients funds for payment of the client costs;
otherwise billing professional service fees for the client on a different basis; and
electronically collecting the client cost and entering a credit for payment of the cost in the law firm accounting system.
